(19) United States
(12) Patent Application Publication
(10) Pub. No.: US 2007/0296962 A1
(43) Pub. Date: Dec. 27, 2007

(54) SURFACE INSPECTION APPARATUS AND SURFACE INSPECTION METHOD

(76) Inventor: Akio Ishikawa, Tokyo (JP)

Correspondence Address: CHRISTIE, PARKER & HALE, LLP, PO BOX 7068, PASADENA, CA, 91109-7068, US

(21) Appl. No.: 11/762,004

(22) Filed: Jun. 12, 2007

(30) Foreign Application Priority Data
Jun. 22, 2006 (JP) 2006-172393

(51) Int. Cl. G01N 21/88

(52) U.S. Cl. 356/237.5

(57) ABSTRACT

A surface inspection apparatus (1) for detecting a defect appearing on the surface of a sample (2) on which a pattern has been formed by a prescribed manufacturing process comprises: a defect detection unit (20, 24) for detecting a defect appearing on the surface of the sample (2); and a process recipe evaluation information acquiring unit (53) for acquiring prescribed process recipe evaluation information based on a detection result obtained when a known standard defect formed in advance on the sample by the manufacturing process is detected by the defect detection unit (20, 24), the prescribed process recipe evaluation information differing depending on the process recipe used in the prescribed manufacturing process.

### CROSS REFERENCE TO RELATED APPLICATION

This application is based upon and claims the benefit of priority from the prior Japanese Patent Application No. 2006-172393, filed on Jun. 22, 2006, the entire contents of which are incorporated herein by reference.

### BACKGROUND OF THE INVENTION

1. Field of the Invention

The present invention relates to a surface inspection apparatus and surface inspection method for detecting a defect (for example, a pattern defect) appearing on the surface of a sample, such as a semiconductor wafer, a photomask substrate, a liquid crystal display panel substrate, or a liquid crystal device substrate, based on captured image of the surface of the sample. More specifically, the invention relates to a technique for performing surface inspection to detect a defect appearing on the surface of a sample on which a pattern has been formed by a prescribed manufacturing process, while making it possible, simultaneously with surface inspection, to judge the suitability of a process recipe used in the manufacturing process. The invention also relates to a method for selecting a recipe to be advantageously used in the manufacturing process.

2. Description of the Related Art

The manufacturing process of a semiconductor device, such as a semiconductor wafer, a photomask, a liquid crystal display panel, or the like, comprises many processing steps, and it is important from the standpoint of improving manufacturing yields to inspect the occurrence of defects at intermediate steps, as well as at the final step and to feed the results back for use in the manufacturing process. To detect such defects during the manufacturing process, inspect, such as a pattern defect inspection, is widely practiced for detecting defects appearing in a pattern formed on the surface of a sample such as a semiconductor wafer, a photomask substrate, a liquid crystal display panel substrate, a liquid crystal device substrate, or the like.

The following description will be given by taking as an example a semiconductor wafer surface inspection apparatus for inspecting defects in a pattern formed on a semiconductor wafer. However, the present invention is not limited to this particular type of apparatus, but can be widely applied to a surface inspection apparatus' for inspecting semiconductor devices such as semiconductor memory photomask substrates, liquid crystal device substrates, liquid crystal display panel substrates, and the like.

FIG. 1 shows a block diagram of a surface inspection apparatus similar to the one that the applicant of this patent application proposed in Japanese Patent Application No. 2003-188209. Generally, the surface inspection apparatus 1 comprises a microscope unit 10 for capturing the image of a semiconductor wafer 2 (hereinafter simply called the “wafer 2”) and an image processing unit 20 for detecting a defect appearing on the surface of the wafer 2 by analyzing the captured image.

In the microscope unit 10, a sample holder (chuck stage) 12 is mounted on the upper surface of a stage 11, which is freely movable in two directions. The wafer 2 as a sample to be inspected is placed on the sample holder 12 and fixed thereon. The stage 11 moves in two directions, i.e., in X and Y directions, in accordance with a control signal from a stage control unit 18. Further, by moving the sample holder 12 up and down along the Z direction, the wafer 2 can be moved in three directions.

A microscope unit 10 comprises an objective lens 13 through which an optical image of the surface of the wafer 2 is projected, and an image capturing unit 14, which captures the optical image of the surface of the wafer 2 projected through the objective lens 13. The image capturing unit 14 is constructed from an image sensor such as a one-dimensional or two-dimensional CCD camera, preferably a TDI camera, and converts the optical image of the surface of the wafer 2 focused on its light receiving surface into an electrical signal. In the illustrated example, the image capturing unit 14 is constructed from a one-dimensional TDI camera, and the stage control unit 18 causes the stage 11 to move so that the image capturing unit 14 scans the wafer 2 at a constant speed in the X or Y direction.

The microscope unit 10 further comprises a light source 15 for illuminating the wafer 2, a light-gathering lens 16, and a half mirror (beam splitter) 17 placed in the projection light path of the objective lens 13. The half mirror 17 reflects illuminating light gathered by the light-gathering lens 16 toward the objective lens 13, and transmits therethrough the optical image of the surface of the wafer 2 that the objective lens 13 projects toward the light receiving surface of the image capturing unit 17.

Such illumination, known as Kohler illumination, provides bright-field light for illuminating the surface of the wafer 2 from the vertical direction containing the optical axis of the objective lens 13, and the image capturing unit 14 captures the image of the light specularly reflected at the thus illuminated wafer 2.

For simplicity of explanation, the following description will be given by taking as an example a surface inspection apparatus equipped with a bright field illumination optical system, but the present invention is not limited to this type of optical system. Some surface inspection apparatus' employ a dark field optical system, which does not directly capture illuminated light, and the present invention is also applicable to a surface inspection apparatus equipped with a dark field optical system. In the case of dark field illumination, the wafer is illuminated from an oblique or vertical direction, and a sensor is disposed so as to not detect specularly reflected light. The dark field image of the surface of the object is obtained by sequentially scanning the surface with illuminated light. Accordingly, certain types of dark field apparatus' may not use image sensors, but such apparatus all fall within the scope of the present invention.

The image signal output from the image capturing unit 14 is converted into a multi-valued digital signal (gray level signal), which is then stored in a signal storing unit 21 in the image processing unit 20.

As shown in FIG. 2, a plurality of dies (chips) 3 are formed on the wafer 2 in a matrix pattern in a repeated fashion in X and Y directions. Since the same pattern is formed on each die, captured images of these dies should normally be identical to each other, and therefore, the pixel values of the corresponding portions of the captured images should normally be the same.

Accordingly, by detecting the pixel value difference (gray level difference) between the corresponding portions of the captured images of any two dies, the presence or absence of a defect can be detected, because the gray level difference signal is greater when there is a defect in either one of the dies than when there is no defect in either die (die-to-die comparison).

Likewise, when repeated patterns, such as memory cells, are formed within each die, the presence or absence of a defect can be detected by detecting the gray level difference between the images captured from a plurality of portions of the repeated patterns that should normally be identical to each other (cell-to-cell comparison).

In the die-to-die comparison, it is general practice to compare the captured images from two adjacent dies (single detection). In this case, however, there is no way to know which die contains the detected defect. Therefore, the die is further compared with a die adjacent on a different side, and if the gray level difference in the same portion is larger than a threshold value, then the die under inspection contains a defect (double detection). The same applies to the cell-to-cell comparison.

Turning back to FIG. 1, the image processing unit 20 includes a difference detection unit 22 for calculating the gray level difference between the corresponding portions of the images captured of two dies in the image of the wafer 2 stored in the signal storing unit 21.

While the stage 11 is being moved by the stage control unit 18 causing the image capturing unit 14 to scan the wafer 2, output signals from the image capturing unit 14 constructed from a one-dimensional TDI camera are captured and the image of the wafer 2 is thus stored in the signal storing unit 21.

In the die-to-die comparison, the difference detection unit 22 retrieves from the signal storing unit 21 sub-images representing corresponding portions of a plurality of adjacent dies based on the position information of the stage 11 supplied from the stage control unit 18, and uses one of the sub-images as an inspection image and the other as a reference image. Then, a signal representing the gray level difference between corresponding pixels in the inspection and reference images is computed, and the result is supplied to a detection threshold value calculation unit 23 and a defect detection unit 24.

In the cell-to-cell comparison, the difference detection unit 22 likewise retrieves sub-images representing corresponding portions of a plurality of adjacent cells from the signal storing unit 21, uses one of the sub-images as an inspection image and the other as a reference image, and computes the gray level difference between them.

The threshold value calculation unit 23 determines the defect detection threshold value based on the gray level difference, and supplies it to the defect detection unit 24. The defect detection unit 24 detects a defect contained in the inspection image by comparing the gray level difference supplied from the difference detection unit 22 with the defect detection threshold value determined by the threshold value calculation unit 23.

More specifically, when the gray level difference signal exceeds a defect detection threshold value, the defect detection unit 24 determines that the inspection image contains a defect at the position of the pixel for which the gray level difference signal was computed.

Then, for each detected defect, the defect detection unit 24 creates and outputs defect information, which includes information such as the position and size of the defect, the gray level value of the defective portion detected in the captured image, and the gray level difference signal between the inspection image and the reference image for the defective portion.

The surface inspection apparatus that performs the die-to-die comparison or cell-to-cell comparison described above is able to detect defects existing on the surface of the wafer surface, but is not able to check whether the manufacturing process used to form the pattern appearing on the wafer surface is suitable, since repeated patterns on the same wafer are formed using the same manufacturing process, if the cause of the defect lies in the manufacturing process or its process recipe, the comparison between the corresponding portions of the repeated patterns does not yield any difference.

In the prior art, the suitability of the manufacturing process, for example, in the case of a photolithographic process, has been checked by observing the specific portions (generally, about five portions) on the wafer surface, under an SEM (Scanning Electron Microscope) and measuring the dimensions of the pattern. Consequently, this has required separate work for inspection that is different from surface inspection.

### SUMMARY OF THE INVENTION

In view of the above problem, it is an object of the present invention to provide a surface inspection apparatus and surface inspection method that can perform surface inspection to detect a defect appearing on the surface of a wafer, while making it possible to simultaneously check whether or not the manufacturing process used to form the pattern appearing on the surface of the wafer is suitable.

To achieve the above object, a known defect is formed on the wafer, and it is checked whether or not this defect can be detected by the surface inspection apparatus. The known defect thus formed on an actual wafer will be referred to as the “standard defect.”

That is, by forming the standard defect using the same manufacturing process as that used for the formation of a pattern on the wafer, and by referring to the result obtained by detecting the standard defect, it can be confirmed that at least a pattern about the same size as the standard defect can be formed using the same manufacturing process.

Here, if the standard defect is formed on the surface of the wafer actually subjected to surface inspection (hereinafter referred to as the “actual wafer” as distinguished from a dummy wafer), the suitability of the manufacturing process can be checked while performing the surface inspection of the actual wafer at the same time.

According to a first mode of the present invention, there is provided a surface inspection apparatus for detecting a defect appearing on the surface of a sample on which a pattern has been formed by a prescribed manufacturing process, comprising: a defect detection unit, which detects a defect appearing on the surface of the sample; and a process recipe evaluation information acquiring unit, which acquires prescribed process recipe evaluation information, which differs depending on a process recipe used in the prescribed manufacturing process. Here, the process recipe evaluation information acquiring unit acquires the prescribed process recipe evaluation information based on a detection result obtained when a known standard defect formed in advance on the sample by the manufacturing process is detected by the defect detection unit.

The process recipe evaluation information can be created using various kinds of information that the surface inspection apparatus can acquire, such as detection or non-detection of the standard defect, the number of standard defects detected within a prescribed range, or the size, etc., of the detected standard defect.

The suitability of the process recipe can be determined by providing a process recipe suitability judging unit which, based on the process recipe evaluation information, judges the suitability of the process recipe corresponding to the process recipe evaluation information.

Using the surface inspection apparatus of the present invention, it is also possible to select the process recipe to be advantageously used in the prescribed manufacturing process. For this purpose, a standard defect selecting unit is provided, which selects from among a plurality of standard defects formed by changing the process recipe, a standard defect for which the process recipe evaluation information acquired by the process recipe evaluation information acquiring unit satisfies a prescribed condition.

By selecting the standard defect in this way, the process recipe used when forming the standard defect can be specified as the advantageous process recipe.

The surface inspection apparatus may further comprise: a process recipe information storing unit, which stores process recipe information designating a process recipe corresponding to each one of the plurality of standard defects; and a process recipe selecting unit which selects, from among the process recipe information stored in the process recipe information storing unit, process recipe information that corresponds to the standard defect selected by the standard defect selecting unit.

Likewise, according to a second mode of the present invention, there is provided a surface inspection method for detecting a defect appearing on the surface of a sample on which a pattern has been formed by a prescribed manufacturing process, comprising: forming a prescribed standard defect on the sample by the manufacturing process; detecting a defect appearing on the surface of the sample; and based on a detection result of the standard defect, acquiring prescribed process recipe evaluation information, which differs depending on a process recipe used in the prescribed manufacturing process.

Then, the suitability of the process recipe used in the prescribed manufacturing process is determined based on the process recipe evaluation information.

Further, according to the surface inspection method of the present invention, from among a plurality of standard defects formed by changing the process recipe, a standard defect for which the acquired process recipe evaluation information satisfies a prescribed condition is selected. Then, from among process recipes respectively corresponding to the plurality of standard defects, a process recipe that corresponds to the selected standard defect is selected.

### BRIEF DESCRIPTION OF THE DRAWINGS

The present invention will be more clearly understood from the description as set out below with reference to the accompanying drawings, wherein:

FIG. 1 is a block diagram of a surface inspection apparatus according to the prior art;

FIG. 2 is a diagram showing an arrangement of dies on a semiconductor wafer;

FIG. 3 is a block diagram of a surface inspection apparatus according to an embodiment of the present invention;

FIG. 4 is a diagram showing an example of an arrangement of standard defects;

FIGS. 5A and 5B show examples of standard defects formed under different exposure conditions;

FIG. 6 is a block diagram showing one configuration example of a manufacturing process management unit shown in FIG. 3;

FIG. 7 is a flowchart illustrating a method for judging the suitability of a process recipe in the manufacturing process management unit shown in FIG. 6; and

FIG. 8 is a flowchart illustrating a method for selecting a process recipe in the manufacturing process management unit shown in FIG. 6.

### DESCRIPTION OF THE PREFERRED EMBODIMENTS

The preferred embodiments of the present invention will be described in detail below while referring to the attached figures. FIG. 3 is a general block diagram of a surface inspection apparatus according to an embodiment of the present invention. The surface inspection apparatus 1 is an apparatus for detecting a defect appearing on the surface of an actual wafer 2 on which a prescribed pattern such as a circuit pattern has been formed by one or a plurality of successive manufacturing processes.

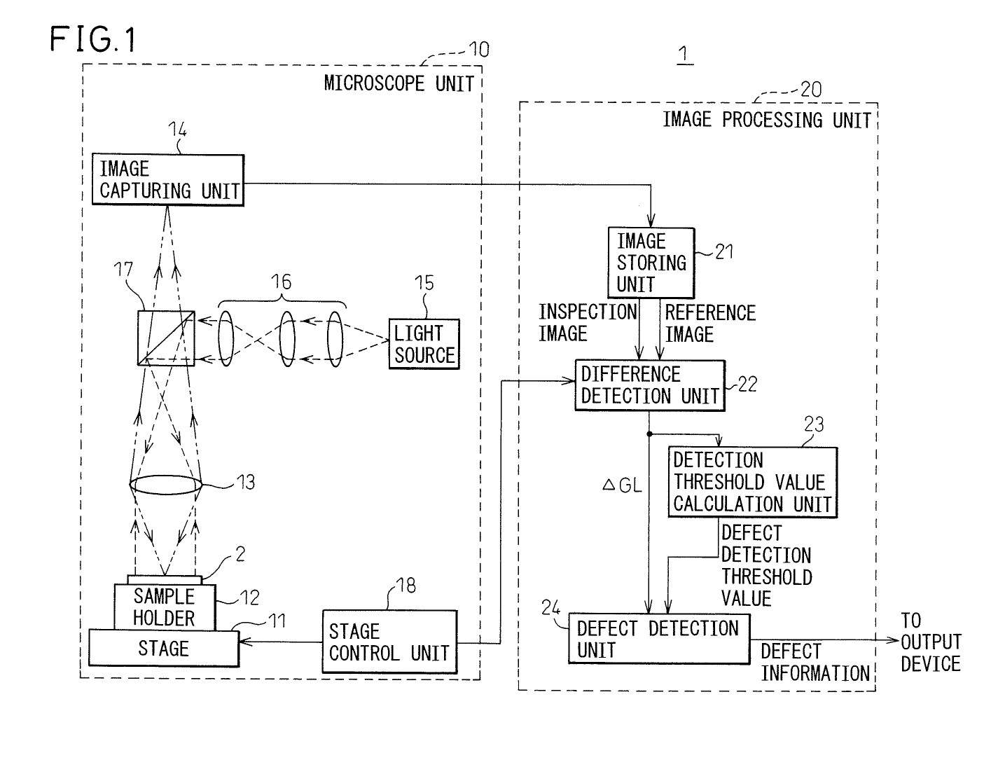

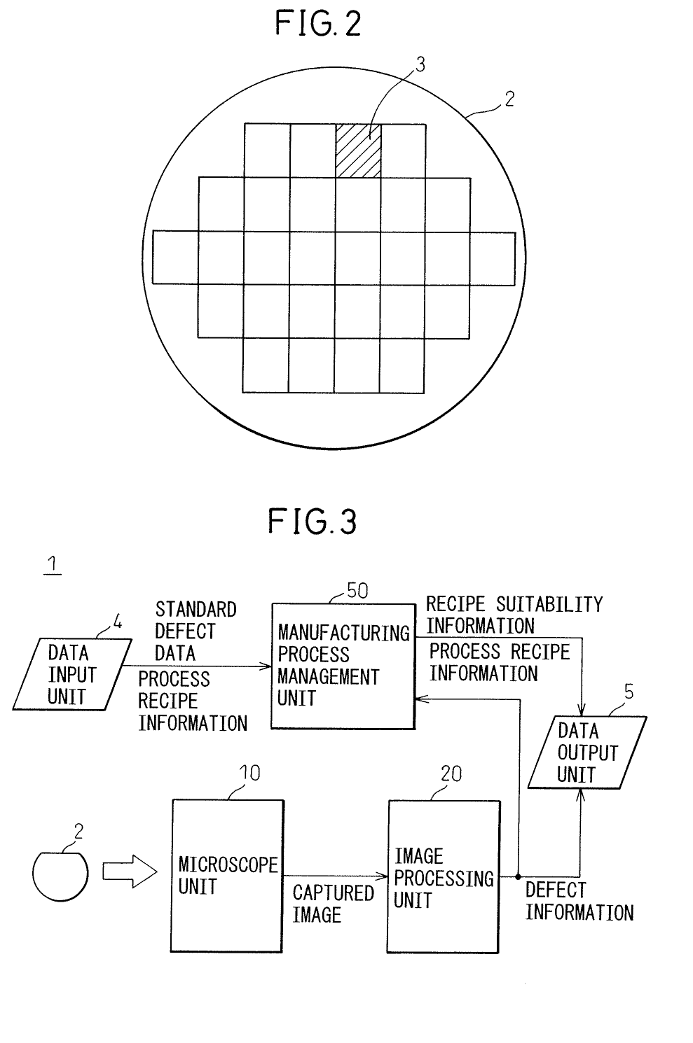

The surface inspection apparatus 1 detects a defect appearing on the surface of the real wafer 2 by using the same method as that employed in the prior art surface inspection apparatus described earlier with reference to FIGS. 1 and 2, and comprises, like the prior art surface inspection apparatus, a microscope unit 10 as an optical system for acquiring an image by capturing an optical image of the surface of an actual wafer 2 and an image processing unit 20, which inputs the image captured by the microscope unit 10 and detects a defect appearing in the captured image.

The microscope unit 10 and the image processing unit 20 shown in FIG. 3 are the same configuration as the microscope unit 10 and the image processing unit 20 previously described with reference to FIG. 1, and therefore, the same component elements are designated by the same reference numerals, and the description of the same functions will not be repeated hereafter.

The surface inspection apparatus 1 according to the embodiment of the present invention further comprises a manufacturing process management unit 50. When a prescribed standard defect is formed on the surface of the actual wafer 2, as will be described later, the image processing unit 20 detects the standard defect and supplies the result to the manufacturing process management unit 50, which based on the result of the detection, judges the suitability of the process recipe used in the prescribed manufacturing process to form the standard defect or selects the process recipe that can be advantageously used in the manufacturing process.

Here, the image processing unit 20 and the manufacturing process management unit 50 may be implemented using a computer or the like that performs data processing and calculations.

The term “process recipe” used here refers to, for example, in the case of a semiconductor circuit manufacturing process, to a set of items for specifying the modes of wafer processing in the manufacturing process, including specification of setting conditions for semiconductor circuit manufacturing equipment such as exposure equipment, film deposition equipment, etching equipment, cleaning equipment, etc. used in the manufacturing process, as well as specification of the kinds of chemicals and gases used in the above equipment, their mixing ratios, and various other conditions, such as processing time and processing temperatures. In other words, the term includes everything generally referred to as a “recipe” in the manufacturing processes of semiconductor wafers, photomasks, and liquid crystal display panels.

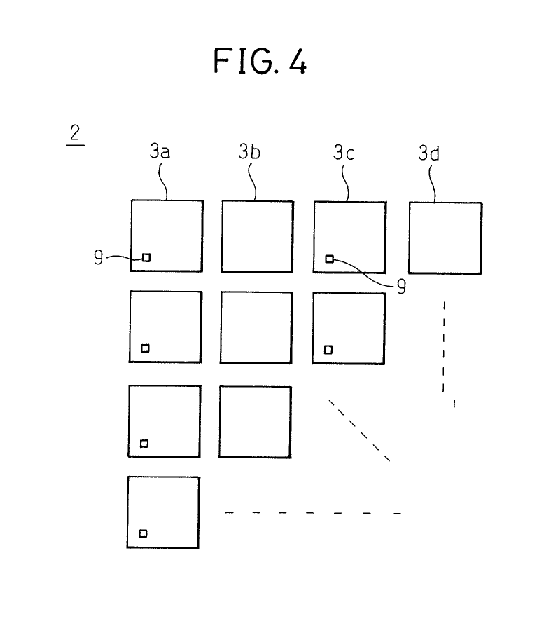

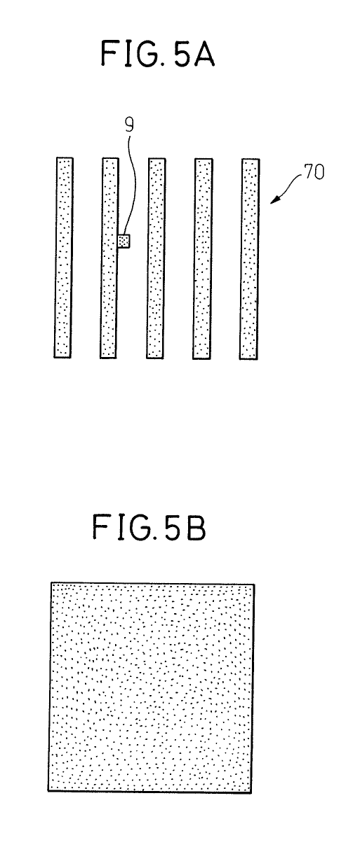

FIG. 4 shows an example of an arrangement of standard defects formed by the above-mentioned prescribed manufacturing process. A plurality of dies 3a, 3b, 3c, 3d, . . . are arranged in a matrix pattern in repeated fashion in X and Y directions. The standard defects 9 may be provided, for example, one for every other die or one for every plurality of dies arranged in a repeated fashion. When the surface inspection apparatus 1 performs a die-to-die comparison between two adjacent dies, if the standard defects 9 are provided as just described, the defect detection unit 24 in the image processing unit 20 can detect the standard defect 9, because the gray level of the image captured from the portion of the standard defect 9 formed in one adjacent die 3a differs from the gray level of the image captured from the corresponding portion in the other adjacent die 3b.

Likewise, when the surface inspection apparatus 1 performs a cell-to-cell comparison between adjacent cells, the standard defects 9 may provide one for every other cell or one for every plurality of cells arranged in a repeated fashion.

Each standard defect 9 is formed in an unused portion within a die or near a die so that, if it is formed on the actual wafer, the wafer will not be rendered defective. If the standard defect 9 is to be used for judging the acceptability of the detection sensitivity of the surface inspection apparatus 1 or for checking the condition of the apparatus, it is desirable that the standard defect 9 be formed so as to have the minimum feature size that the surface inspection apparatus 1 can detect.

The pattern formed on the wafer 2 differs depending on the process recipe used in the manufacturing process for the formation of the pattern. Therefore, if the standard defect 9 is formed so as to have the minimum feature size that the manufacturing process can form on the wafer 2, the standard defect 9 is not formed on the wafer 2 unless the process recipe is appropriate.

FIGS. 5A and 5B show examples of patterns that occur when the standard defect 9 is formed by varying the exposure conditions in the photolithography process as one example of an item prescribed in the process recipe. Here, FIG. 5A shows the pattern formed under optimum exposure conditions, and FIG. 5B shows the pattern formed when the amount of exposure was insufficient.

As shown in FIG. 5A, in a case where the standard defect 9 having the same shape as a short pattern is formed within a parallel line pattern 70 having a line width of the minimum dimension that can be formed by the manufacturing process, the dimension of the standard defect 9 is also the minimum dimension that can be formed by the manufacturing process.

If this pattern is formed in underexposed conditions, then as shown in FIG. 5B the parallel line pattern is not resolved, and the standard defect 9 formed therein is not resolved either, and as a result, the standard defect 9 cannot be detected by the surface inspection.

Accordingly, by forming the standard defect 9 using the same manufacturing process as that used for forming the pattern on the real wafer 2 to be inspected, and by checking whether the standard defect 9 can be detected by the surface inspection, it is possible to determine the suitability of the process recipe used in the manufacturing process for forming the pattern on the surface of the real wafer 2.

Turning back to FIG. 3, when the image of the surface of the actual wafer 2 with the standard defect 9 formed thereon is captured by the microscope unit 10, and the captured image is input to the signal processing unit 20, the signal processing unit 20, which comprises the signal storing unit 21, difference detection unit 22, detection threshold value calculation unit 23, and defect detection unit 24, detects defects appearing on the surface of the wafer 2, including the standard defect 9, and outputs the defect information for each detected defect, as in the surface inspection method previously described with reference to FIGS. 1 and 2.

The manufacturing process management unit 50 receives each defect information from the defect detection unit 24, and selects the defect information concerning the standard defect 9 from among the thus received defect information in order to check the result of the detection of the standard defect 9 accomplished by the image processing unit 20. At this time, the manufacturing process management unit 50 compares the received defect information with standard defect data, i.e., the known information concerning the standard defect 9 formed on the surface of the actual wafer 2, and determines whether the received defect information is the defect information concerning the standard defect 9.

Standard defect data may include die designation information designating the die in which the standard defect 9 is provided and defect position information indicating the position within the die at which the standard defect 9 is provided. Standard defect data may further include standard defect mode information, such as the size of the standard defect 9, and the gray level value that the pixel in the portion of the standard defect 9 shows when the image is captured under optical conditions optimum for the surface inspection.

Standard defect data may further include, for example, the gray level difference that occurs between the portion containing the standard defect 9 and other portions within the captured image (i.e., the gray level difference between the inspection image and the reference image for the portion of the standard defect 9) when an image comparison similar to the one performed in the surface inspection method previously described with reference to FIGS. 1 and 2 is performed using the image captured under optical conditions optimum for the surface inspection.

If the standard defect data includes data concerning more than one standard defect 9, identifier information for identifying each individual standard defect 9 may be included.

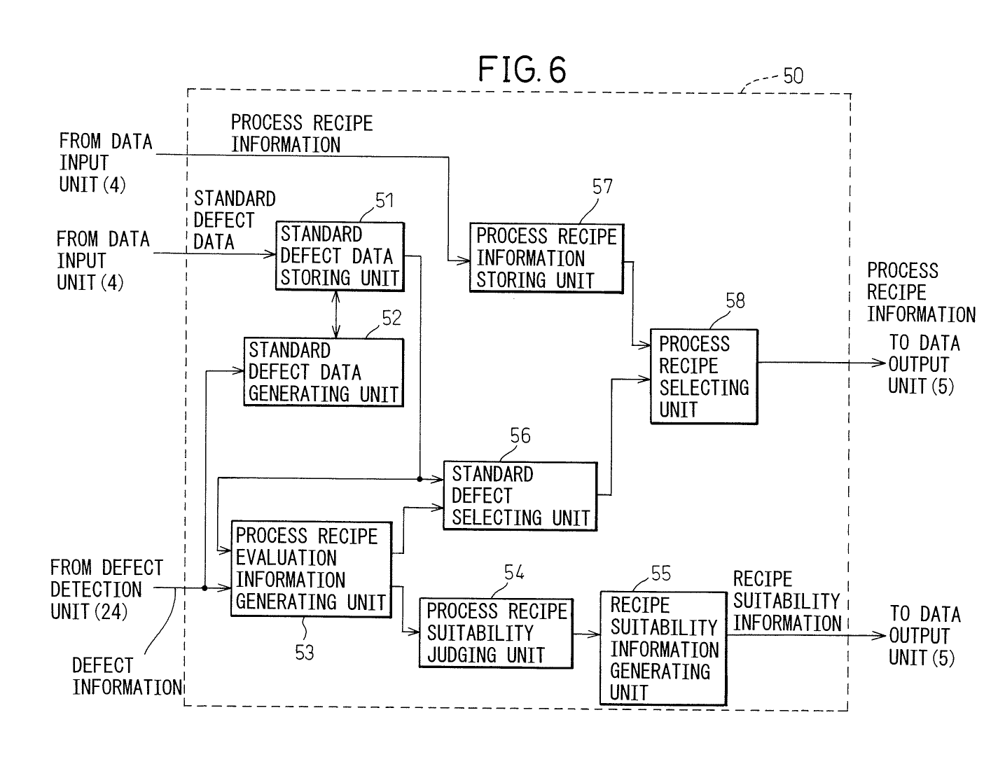

The standard defect data may be generated externally to the surface inspection apparatus 1 based on the design data used when forming the standard defect 9 on the actual wafer 2, or as will be described later, some of the earlier listed items of the standard defect data (position information, size, gray level value, gray level difference, etc.) may be generated by a standard defect data generating unit 52 in the manufacturing process management unit 50 to be described later with reference to FIG. 6.

However, when the actual wafer 2 is used for the first time on which the standard defect 9 has been formed, it is preferable that at least the position information of the standard defect 9 be supplied externally to the surface inspection apparatus 1. For this purpose, the surface inspection apparatus 1 includes a data input unit 4 for inputting at least a portion of the standard defect data concerning the standard defect 9 to the manufacturing process management unit 50.

The data input unit 4 may be constructed from any one of input devices selected, for example, from the group consisting of a user interface such as a keyboard, mouse, touch panel, etc., that an operator uses to input data, a removable media reading device such as a flexible disk drive, a CD-ROM drive, or a memory reading device for reading data provided in the form of a removable medium such as a flexible disk, a CD-ROM, or a memory card, and an interface device for inputting the data.

The manufacturing process management unit 50, based on the result of the detection of the standard defect 9, determines the suitability of the process recipe used in the prescribed manufacturing process for the formation of the standard defect 9, and outputs recipe suitability information indicating whether or not the process recipe is suitable. The surface inspection apparatus 1 includes a data output unit 5 for outputting the recipe suitability information outside the surface inspection apparatus 1.

The data output unit 5 may be constructed from any one of output devices selected, for example, from the group consisting of a display device such as a CRT or a liquid crystal display panel on which the data to be output is displayed, a printer for printing the data on paper, a removable media writing device such as a flexible disk drive, a CD-ROM drive, or a memory writing device for storing the data to be output and for writing the data to a removable medium such as a flexible disk, a CD-ROM, or a memory card, and an interface device for outputting the data.

The defect information output from the image processing unit 20 is also output outside the surface inspection apparatus 1 via the data output unit 5.

The manufacturing process management unit 50 also has the function of selecting, based on the result of the detection of the standard defect 9, the process recipe that can be advantageously used in the same manufacturing process as that used for the formation of the standard defect 9.

When the manufacturing process management unit 50 selects the advantageous process recipe in this way, a plurality of standard defects 9 are formed in advance on the wafer 2 by changing the process recipe. Or when the process recipe to be changed is one that concerns processing conditions, such as etching and that has to be set for each individual wafer, a plurality of wafers 2 are processed by changing the process recipe, and a plurality of standard defects are formed.

On the other hand, information concerning the process recipes respectively used for the formation of the plurality of standard defects 9 (hereinafter referred to as the “process recipe information”) is input to the manufacturing process management unit 50 via the data input unit 4. The process recipe information may itself be the values that specify the earlier listed modes of wafer processing in the manufacturing process or may be an identifier for identifying each individual process recipe.

Process recipe information may be included in the standard defect data relating to the standard defect formed by using the corresponding recipe. Alternatively, the process recipe information may be input separately from the standard defect data. In this case, an identifier may be assigned to each process recipe information, and the identifier of the process recipe information used when forming the corresponding standard defect may be included in the standard defect data.

Based on the result of the detection of each of the plurality of standard defects 9 formed by changing the process recipe, the manufacturing process management unit 50 selects the process recipe that can be used advantageously, and outputs the process recipe information for the selected process recipe. The process recipe information is output outside the surface inspection apparatus 1 via the data output unit 5.

The configuration and operation of the manufacturing process management unit 50 will be described below.

FIG. 6 is a block diagram showing one configuration example of the manufacturing process management unit 50 shown in FIG. 3. The manufacturing process management unit 50 includes a standard defect data storing unit 51 which stores the standard defect data input from the input unit 4 as information concerning the standard defect 9 formed on the real wafer 2. The manufacturing process management unit 50 may further include a standard defect data generating unit 52 for generating some of the earlier listed items of the standard defect data (position information, size, gray level value, gray level difference, etc.) within the manufacturing process management unit 50.

The manufacturing process management unit 50 further includes a process recipe evaluation information generating unit 53, which takes as an input defect information output from the defect detection unit 24, and based on this defect information creates prescribed process recipe evaluation information, which differs depending on the process recipe used in the manufacturing process for the formation of the standard defect 9.

The process recipe evaluation information may be generated as information that indicates, for example, the detection or non-detection of the standard defect 9. In this case, the process recipe evaluation information generating unit 53 may determine whether or not the standard defect 9 has been detected, by referring to the standard defect data stored in the standard defect data storing unit 51, and thereby checking whether or not the defect detected at the known position of the standard defect 9 indicated by the standard defect data is included in the input defect information.

Further, the process recipe evaluation information may be generated as information that indicates the number of standard defects detected, for example, within a prescribed range. In this case, the process recipe evaluation information generating unit 53 may obtain the number of detected standard defects 9 by determining the detection or non-detection for each standard defect 9 in the same manner as described above. Alternatively, the defect information concerning the standard defect 9 detected within the prescribed range may itself be generated as the process recipe evaluation information.

Further, the process recipe evaluation information may be generated as information that indicates the size of the detected standard defect 9. In this case, the process recipe evaluation information generating unit 53 extracts defect information concerning the detected standard defect 9 from the input defect information by using, for example, the position information included in the standard defect data stored in the standard defect data storing unit 51, and acquires the defect size included in the defect information.

The manufacturing process management unit 50 further includes a process recipe suitability judging unit 54 which, based on the process recipe evaluation information output from the process recipe evaluation information generating unit 53, judges in accordance with prescribed criteria the suitability of the process recipe used in the manufacturing process for the formation of the standard defect 9, and a recipe suitability information generating unit 55, which generates recipe suitability information indicating the result of the judgment made by the process recipe suitability judging unit 54, and supplies the information to the data output unit 5.

The process recipe suitability judging unit 54 judges the suitability of the process recipe based, for example, on the result of the determination made as to the detection or non-detection of the standard defect 9, which is indicated by the process recipe evaluation information. In others words, if the standard defect 9 is detected, it is determined that a pattern about the same size (for example, line width, etc.) as the standard defect 9 can be formed using the same process recipe, but if the standard defect is not detected, it is determined that a pattern of this size cannot be formed using the same process recipe.

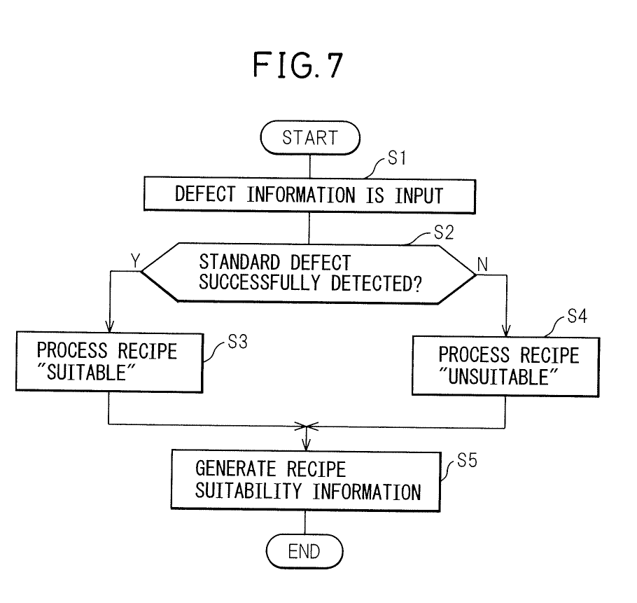

FIG. 7 is a flowchart illustrating a method for judging the suitability of the process recipe in the manufacturing process management unit 50 shown in FIG. 6.

In step S1, when the image of the surface of the actual wafer 2 with the standard defect 9 formed thereon is captured by the microscope unit 10, and the captured image is input to the signal processing unit 20, the defect detection unit 24 in the signal processing unit 20 detects a defect appearing on the surface of the wafer 2, and outputs its defect information. The defect information thus output is input to the process recipe evaluation information generating unit 53 in the manufacturing process management unit 50.

In step S2, the process recipe evaluation information generating unit 53 compares the position information of the defect included in the input defect information with the position information of the standard defect stored in the standard defect data storing unit 51, determines whether the standard defect 9 has been detected by the image processing unit 20, generates the process recipe evaluation information indicating the detection or non-detection of the standard defect 9, and supplies the evaluation information to the process recipe suitability judging unit 54.

If the process recipe evaluation information indicates that the standard defect 9 has been detected, the process recipe suitability judging unit 54 determines that the process recipe used for the formation of the standard defect 9 is suitable (step S3). However, if the information indicates a non-detection, it is determined that the process recipe used for the formation of the standard defect 9 is unsuitable (step S4). In step S5, the recipe suitability information generating unit 55 generates recipe suitability information indicating the result of the judgment made by the process recipe suitability judging unit 54, and supplies the information to the data output unit 5.

Here, in step S2, the process recipe evaluation information generating unit 53 may retrieve the defect size of the detected defect from the defect information concerning the detected standard defect 9, and generate the process recipe evaluation information by including the defect size therein.

Then, when judging the suitability of the process recipe, the process recipe suitability judging unit 54 may compare the defect size included in the process recipe evaluation information with the size of the standard defect 9 included in the standard defect data, and if the difference is within a prescribed range, it is determined that the standard defect 9 is correctly formed on the wafer 5, and therefore the process recipe used for the formation of the standard defect 9 is suitable. However, it is determined that the process recipe is unsuitable if the difference is outside the prescribed range.

Turning back to FIG. 6, the manufacturing process management unit 50 further includes a standard defect selecting unit 56, a process recipe information storing unit 57, and a process recipe selecting unit 58.

In the case where a plurality of standard defects 9 are formed on the wafer 2 by changing the process recipe, each of these standard defects 9 is detected by the defect detection unit 24, by checking, for example, which of the plurality of standard defects 9 is detected, an advantageous process recipe can be determined for the manufacturing process used for the formation of the detected standard defect 9.

In view of this, the standard defect selecting unit 56 selects, from among the plurality of standard defects 9 formed by changing the process recipe, the standard defect for which the process recipe evaluation information acquired by the process recipe evaluation information acquiring unit 53 satisfies a prescribed condition.

On the other hand, the process recipe information storing unit 57 stores the process recipe information received via the data input unit 4 for the respective process recipes used for the formation of the plurality of standard defects 9.

Here, it is understood that each process recipe information contains an identifier for uniquely identifying each individual process recipe information, and that the standard defect data stored in the standard defect data storing unit 51 contains the identifier of the process recipe information corresponding to the process recipe used for the formation of the standard defect 9.

Process recipe information may be stored in the standard defect data storing unit 51 by including it in the standard defect data concerning the standard defect formed by using the corresponding recipe.

The process recipe selecting unit 58 retrieves from the process recipe information storing unit 57 the process recipe information corresponding to the process recipe used for the formation of the standard defect 9 selected by the standard defect selecting unit 56, and supplies to the data output unit 5 the process recipe information indicating the process recipe that can be advantageously used in the same manufacturing process as that used for the formation of the standard defect 9.

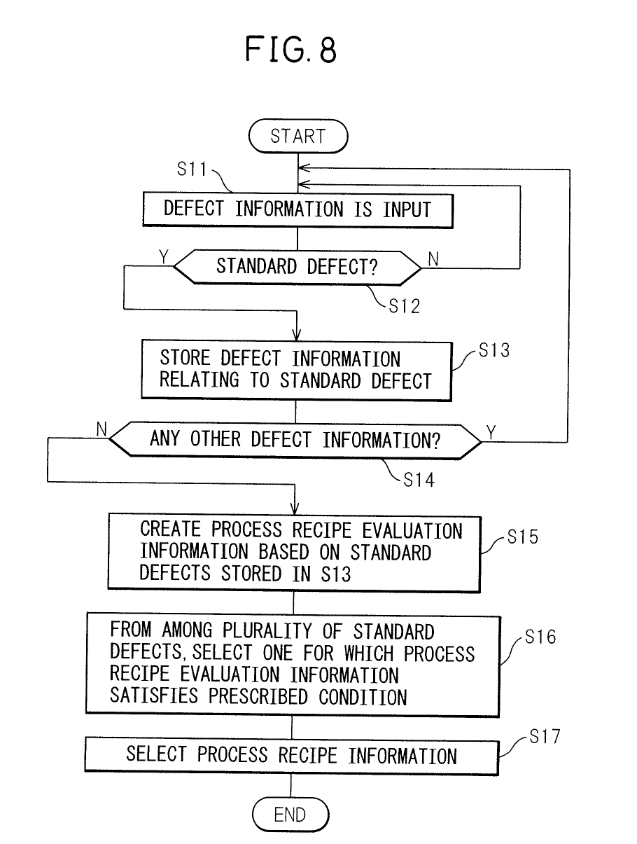

FIG. 8 is a flowchart illustrating a method for selecting the process recipe in the manufacturing process management unit 50 shown in FIG. 6.

In this method, defect information concerning the plurality of standard defects 9 formed by changing the process recipe is successively stored by repeating the routine of steps S11 to S14.

First in step S11, the defect detection unit 24 detects a defect on the surface of the actual wafer 2, generates its defect information, and supplies it to the process recipe evaluation information generating unit 53. In step S12, the process recipe evaluation information generating unit 53 determines whether the received defect information is one that concerns the standard defect 9. If the received defect information is not one that concerns the standard defect 9, the process returns to step S11 to wait for an input of defect information. In step S13, the process recipe evaluation information generating unit 53 stores the defect information of the standard defect 9 in a storage means not shown.

Then, in step S14, the process recipe evaluation information generating unit 53 determines whether the defect detection unit 24 has detected all the standard defects 9 formed by changing the process recipe. The process recipe evaluation information generating unit 53 can determine whether all the standard defects 9 have been detected or not, for example, by referring to the position information carried in the received defect information and thereby checking if the defect position indicated by the defect information is the position to be inspected by the defect detection unit 24 at a later time than the position of the standard defect 9.

If there is any standard defect 9 for which the defect information is not received, the process returns to step S11 repeating steps S11 to S14, and when defect information has been received for all the standard defects 9, the process proceeds to step S15.

In step S15, the process recipe evaluation information generating unit 53 creates process recipe evaluation information based on the standard defects 9 whose information has been stored in step S13, and supplies the evaluation information to the standard defect selecting unit 56. In step S16, the standard defect selecting unit 56 selects from among the standard defects the standard defect for which the process recipe information satisfies a prescribed condition.

Then, in step S17, the process recipe selecting unit 58 selects, from among the process recipe information stored in the process recipe information storing unit 57, the process recipe information corresponding to the standard defect 9 selected by the standard defect selecting unit 56, and supplies the selected information to the data output unit 5.

Whether or not a given standard defect 9 has been detected can be determined, for example, by checking if the defect information concerning the given standard defect 9 has been stored in step S13. In step S15, the process recipe evaluation information generating unit 53 supplies the defect information of the standard defect 9, stored in step S13, to the standard defect selecting unit 56 as process recipe evaluation information that indicates detection or non-detection of the standard defect.

Then, in step S16, the standard defect selecting unit 56 selects from among the standard defects 9 the standard defect 9 whose defect information has been received from the process recipe evaluation information generating unit 53 as the standard defect that satisfies the prescribed condition “the defect can be detected by the surface inspection apparatus 1,” and supplies it to the process recipe selecting unit 58.

If, for example, there is more than one standard defect 9 for which defect information has been stored in step S13, the standard defect selecting unit 56 in step S16 selects all of the standard defects and supplies them to the process recipe selecting unit 58.

Then, in step S17, the process recipe selecting unit 58 retrieves from among the process recipe information stored in the process recipe information storing unit 57 the process recipe information corresponding to all the standard defects 9 selected by the standard defect selecting unit 56, takes an intermediate value among the thus retrieved process recipe information as representing the most advantageous process recipe information to be used in the manufacturing process, and supplies the process recipe information to the data output unit 5 after setting upper and lower limit values to allow a margin for the process recipe information.

Among the items previously listed as forming the standard defect data, there are items that are difficult to correctly create unless the image of the standard defect 9 is actually captured. For such items, it is advantageous to generate data from the image captured by the surface inspection apparatus 1, rather than externally providing data to the surface inspection apparatus 1 via the data input unit 4. From the defect information of the detected standard defect 9, the standard defect data generating unit 52 generates data for some of the items of the standard defect data to be stored in the standard defect data storing unit 51.

When generating the standard defect data by the standard defect data generating unit 52, first the standard defect 9 generated by a suitable process recipe is formed on the actual wafer 2. Whether or not the recipe used for the formation of the standard defect 9 is suitable can be determined by forming a number of standard defects 9 by changing the process recipe, and by observing the thus formed standard defects using an SEM or the like. Then, the surface of the actual wafer 2 containing the standard defect 9 is inspected. Further, the position information of the standard defect 9 carried in the standard defect data is input via the data input unit 4 and stored in the standard defect data storing unit 51, while the defect information generated during the surface inspection is input to the standard defect data generating unit 52.

From among the defect information thus input, the standard defect data generating unit 52 selects the defect information associated with the standard defect 9 based on the position information of the standard defect 9 stored in the standard defect data storing unit 51. Then, the size of the defect, the gray level value that the pixel in the portion of the standard defect 9 shows, the gray level difference between the inspection image and the reference image for the standard defect 9, etc., are acquired from the selected defect information, and stored in the standard defect data storing unit 51 as the standard defect data concerning the standard defect 9.

According to the present invention, since the inspection for determining the suitability of the process recipe can be performed simultaneously with surface inspection, the inspection (for example, the SEM inspection) separately performed in the prior art for the management of the manufacturing process, such as the determination of the suitability of the process recipe, can be omitted.

Further, in the prior art, when performing the inspection using an SEM for the determination of the suitability of the process recipe, it was possible to inspect only limited specific portions on the wafer surface because of low throughput, but according to the present invention, the entire surface of the wafer can be inspected because the inspection can be performed simultaneously with surface inspection.

The manufacturing process that can form a pattern about the same size as the standard defect, having a prescribed size, can be determined during surface inspection.

The present invention is applicable to a surface inspection apparatus and surface inspection method for detecting a defect appearing on the surface of a sample, based on an image, etc. captured of the surface of the sample. The invention is particularly applicable to a surface inspection apparatus and surface inspection method for detecting a defect in a pattern formed on the surface of a substrate such as a semiconductor wafer, a photomask, a liquid crystal display panel substrate, or a liquid crystal device substrate, based on an image captured of the surface of the substrate.

While the invention has been described with reference to specific embodiments chosen for purpose of illustration, it should be apparent that numerous modifications could be made thereto by those skilled in the art without departing from the basic concept and scope of the invention.

What is claimed is:

1. A surface inspection apparatus for detecting a defect appearing on the surface of a sample on which a pattern has been formed by a prescribed manufacturing process, comprising:
a defect detection unit, which detects a defect appearing on the surface of said sample; and
a process recipe evaluation information acquiring unit, which acquires prescribed process recipe evaluation information based on a detection result obtained when a known standard defect formed in advance on said sample by said manufacturing process is detected by said defect detection unit, said prescribed process recipe evaluation information differing depending on a process recipe used in said prescribed manufacturing process.

2. A surface inspection apparatus as claimed in claim 1, further comprising a process recipe suitability judging unit, which judges the suitability of said process recipe used in said prescribed manufacturing process based on said process recipe evaluation information acquired by said process recipe evaluation information acquiring unit.

3. A surface inspection apparatus as claimed in claim 1, further comprising a standard defect selecting unit, which selects from among a plurality of said standard defects formed by changing said process recipe, a standard defect for which said process recipe evaluation information acquired by said process recipe evaluation information acquiring unit satisfies a prescribed condition.

4. A surface inspection apparatus as claimed in claim 3, further comprising:
a process recipe information storing unit, which stores process recipe information designating a process recipe corresponding to each one of said plurality of standard defects; and
a process recipe selecting unit, which selects from among the process recipe information stored in said process recipe information storing unit, process recipe information that corresponds to the standard defect selected by said standard defect selecting unit.

5. A surface inspection method for detecting a defect appearing on the surface of a sample on which a pattern has been formed by a prescribed manufacturing process, comprising:
forming a prescribed standard defect on said sample by said manufacturing process;
detecting a defect appearing on the surface of said sample; and
based on a detection result of said standard defect, acquiring prescribed process recipe evaluation information, which differs depending on a process recipe used in said prescribed manufacturing process.

6. A surface inspection method as claimed in claim 5, wherein the suitability of said process recipe used in said prescribed manufacturing process is judged based on said process recipe evaluation information.

7. A surface inspection method as claimed in claim 5, wherein, from among a plurality of said standard defects formed by changing said process recipe, a standard defect for which said acquired process recipe evaluation information satisfies a prescribed condition is selected.

8. A surface inspection method as claimed in claim 7, wherein, from among process recipes respectively corresponding to said plurality of standard defects, a process recipe that corresponds to said selected standard defect is selected.
